(19) United States
(12) Patent Application Publication
(10) Pub. No.: US 2016/0335599 A1
(43) Pub. Date: Nov. 17, 2016

(54) SYSTEMS AND METHODS FOR EXCHANGING INFORMATION

(71) Applicant: Hitoshi KAWANABE, Menlo Park, CA (US)

(72) Inventor: Hitoshi KAWANABE, Menlo Park, CA (US)

(21) Appl. No.: 15/112,829

(22) PCT Filed: Jan. 23, 2015
(86) PCT No.: PCT/US2015/012721

§ 371 Date: Jul. 20, 2016

Related U.S. Application Data
(60) Provisional application No. 61/930,806, filed on Jan. 23, 2014.
(60) Provisional application No. 62/077,138, filed on Nov. 7, 2014.

(51) Int. Cl. G06Q 10/10; H04L 29/08; H04W 4/20; G06Q 50/00

(52) U.S. Cl. CPC G06Q 10/109; G06Q 50/01; H04L 67/10; H04W 4/206

(57) ABSTRACT

A method is provided that includes activating an application on a first device of a first user, and detecting a second device of a second user. The method further includes, in response to a first user input of the first user to the first device and a second user input of the second user to the second device, transmitting first information of the first user to the second decide and transmitting second information of the second user to the first device, and

associating the first information and the second information with social network information of the first user and the second user. Social networking service accounts of the first user and the second user may be associated automatically, and the social graphs of the users may be displayed with respect to other users.

### CROSS-REFERENCE TO RELATED APPLICATIONS

This application is a U.S. National Stage entry of PCT Application No. PCT/US2015/012721, filed on Jan. 23, 2015, the contents of which are incorporated by reference.

### BACKGROUND

1. Field

Aspects of the example implementations relate to at least one system and method for storing and exchanging information, and more specifically, to exchanging information between a device of a first user and a device of a second user.

Additional aspects of the example implementation relate to providing the first user with social graph information of the second user, for the first user and the second user capable of having an in-person meeting.

2. Related Background

Individuals desire to exchange information with other individuals. In the related art, such information may be exchanged in a business setting. For example, during a meeting, individuals may exchange physical business cards with one another. The information of the physical business cards may be viewed and positioned during a meeting, so as to permit the individual to identify other individuals.

During the exchange of information, each individual user only obtains the information of the other individuals at the time of the information exchange. Further, the business card as it is accessed from the other individual only provides static identifying information. While the individual may subsequently scan or enter the data of the business card into an electronic format, the entering of this information does not occur at the same time as the initial exchange of information. Further, the user cannot have any advance notice or clue of the person to be introduced, prior to the introduction.

Further, if, during a meeting, one or more individuals have already met each other, the exchange of business cards, or the asking for a reintroduction may not be performed as a matter of business rule or custom, and may not be acceptable according to many business cultures. Therefore, it is impractical and sometimes impossible to identify individuals who have previously met, based on physical business card exchange alone.

Accordingly, there is an unmet need for a way of exchanging information in real-time between individuals in a manner that does not require subsequent downloading or accessing, and does not require the breaking of business or social customs.

### SUMMARY

According to an example implementation, a computer-implemented method is provided. The method includes activating an application on a first device of a first user; detecting a second device of a second user; in response to a first user input of the first user to the first device and a second user input of the second user to the second device, transmitting first information of the first user to the second decide and transmitting second information of the second user to the first device; and associating the first information and the second information with social network information of the first user and the second user.

The methods are implemented using one or more computing devices and/or systems. The methods may be stored in computer-readable media.

### BRIEF DESCRIPTION OF THE DRAWINGS

FIG. 1 shows a user interface indicative of a first process according a first example implementation.

FIG. 2 shows a user interface indicative of a second process according a first example implementation.

FIG. 3 shows a user interface indicative of a third process according a first example implementation.

FIG. 4 shows a user interface indicative of a fourth process according a first example implementation.

FIG. 5 shows a user interface indicative of a fifth process according a first example implementation.

FIG. 6 shows a user interface indicative of a sixth process according a first example implementation.

FIGS. 7-A to 7-E show a user interface having various seating configurations according to a first example implementation.

FIG. 7-F shows a user interface of selecting from the various seating configurations according to a first example implementation.

FIG. 8 shows a user interface indicative of a first process according a second example implementation.

FIG. 9 shows a user interface indicative of a second process according a second example implementation.

FIG. 10 shows a user interface indicative of a third process according a second example implementation.

FIG. 11 shows a user interface indicative of a fourth process according a second example implementation.

FIG. 12 shows a user interface indicative of a fifth process according a second example implementation.

FIGS. 13-A to 13-C show an example user interface of the information provided to the first user about the social graph of the second user including a plurality of social network services, according to an example implementation.

FIG. 14 illustrates a process flow according to the example implementation, in which the social graph information of the second user is provided to the first user.

FIG. 15 shows a user interface indicative of a sixth process according a second example implementation.

FIG. 16 shows a user interface indicative of a seventh process according a second example implementation.

FIG. 17 shows a user interface indicative of a eighth process according a second example implementation.

FIG. 18 shows a user interface indicative of a ninth process according a second example implementation.

FIG. 19 shows a user interface indicative of a tenth process according a second example implementation.

FIG. 20 illustrates a process flow according to the first example implementation.

FIG. 21 illustrates a process flow according to the second example implementation.

FIG. 22 illustrates a process flow according to a third example implementation.

FIG. 23 shows an example environment suitable for some example implementations.

FIG. 24 shows an example computing environment with an example computing device suitable for use in some example implementations.

### DETAILED DESCRIPTION

The subject matter described herein is taught by way of example implementations. Various details have been omitted for the sake of clarity and to avoid obscuring the subject matter. The examples shown below are directed to structures and functions for implementing systems and methods for exchange of information between users.

According to an example implementation, a system and method is provided for the exchange of information between a first individual and a second individual. The first and second individuals may respectively be first and second users of electronic telecommunication devices. The electronic telecommunication devices may include, but are not limited to, smartphones, tablets, laptops, computers, telephones (mobile or non-mobile), and other wireless communication devices. The devices are capable of communication with other devices.

According to an example method, a user may be in a setting where initial or non-initial exchange of information with another user is desired. Accordingly, the user activates an application via the electronic communication devices. The application may include, but is not limited to, a set of instructions capable of being executed in a non-transitory computer readable medium. The instructions may reside in the electronic telecommunication device at the side of the user (e.g., the client side), at a remote location (e.g., a server side or in a cloud computing environment), or a combination thereof, or on other client devices in a shared processing environment.

Once a user activates the application, the user is provided with a user interface or display. According to an example implementation, the user interface may initially provide an output having an appearance to resemble a cover of a physical business card holder. This initial screen provides the user with an indication that the application has been activated, and is available for further use.

In this mode, the electronic telecommunication device may attempt to determine whether there are other electronic telecommunication devices that have authorized communication with the electronic telecommunication device. For example, but not by way of limitation, the electronic telecommunication device may attempt to detect the presence of other electronic telecommunication devices by wireless communication method or protocol, such as Bluetooth, Wi-Fi, Global Positioning System (GPS), wireless communication protocol such as LTE, or other communication method or protocol as would be understood by those skilled in the art.

Once it is established that other electronic telecommunication devices are in the vicinity of the electronic telecommunication device, further attempts may be made to determine whether the neighboring electronic telecommunication devices have the application activated, and whether the activated application is currently available for exchanging information. If it is determined that the electronic telecommunication devices are in a common vicinity and are configured for communication via the application, the parties may participate in an exchange procedure. In other words, a first device is seeking identifying information of a second device through a wireless infrastructure.

For example, according to one exchange procedure, a user attempts to introduce himself or herself to another user. In order to activate the information exchange process, the user places his or her fingers in a prescribed configuration, such that the touchscreen of the smart phone senses that the process is about to begin. In one example, the placement of the users thumbs at opposite corners of the touchscreen interface of the smart phone indicates to the application that the user is about to commence the exchange process. The placement of the fingers and prescribed configuration may include one or more gestures, including but not limited to a sliding, dragging, flicking, waving or other movement of a user's body part with respect to the input of the electronic communication device.

Optionally, if the other user also has activated the application and is accepting introductory information of the user, the other user may similarly activate the application for information exchange, using his or her own gestures were fingers and a prescribed configuration. However, even if the other user has not activated the application, and it may still be possible for the user to provide more push the information to the other user without mutual exchange of information through the application.

When the application is provided with indication of activation as explained above, the display of the user interface changes from the cover of the business card to the appearance of the business card itself. For example, but not by way of limitation, the interface may show an animation of a business card holder being opened in the business cards being placed on the business card holder. The display is intended to simulate the process of individuals manually exchanging business cards, without requiring physical business card.

Once the user has activated the application and provided an indication that the exchange of introductory information is about to start, the user then performs a subsequent process, such as a sliding on the thumbs along opposite edges of the touchscreen of the smart phone.

As each of the thumbs slide along the opposite edges of the smart phone user interface touchscreen, the image of the business card slides in a common direction with the movement of the thumbs. This animation is designed to provide a visual impression that the user is providing his or her business card to the other user. However, the exchange of business cards is being performed without any physical business card. Instead, as the thumbs of the user travel for more than a prescribed distance or amount of time, the information of the user is provided or pushed to the online account information of the other user.

If the other user also has his or her application open at the same time, and if the other user provides his or her business card information same matter, the other user may receive a display animation on his or her device that shows a business card sliding toward the user. This process simulates the receiving of a physical business card from the user, without actually requiring a physical business card.

According to another example implementation, a single user may simultaneously exchange business cards with a plurality of users according to the foregoing method. Therefore, time may be saved in the initial portion of a meeting, and the simultaneous exchange of such information may permit members of an organization to more efficiently share information.

Further, the information is provided to the other users, and may be stored in an online account. Therefore, when the user has a change in their information, such as change of employer, title, company address, telephone number or other information, this update may be automatically pushed to the other users, such that it is not necessary to exchange additional business card information every time there is a change in contact information, for example.

In a situation where a user may have previously been introduced to another user, but may not recall the information associated with that user, the application may recall the information for the user, without requiring a breaking of custom or rule, or causing embarrassment to the user who does not recall the information of the other user.

Various options exist for a user to control or filter the exchange of information with respect to other users. For example, a user may create a set of whitelists that include other users who are allowed to exchange information. In one example, any members of Company A may be considered to be on a whitelist, such that the application automatically provides users were members of Company A with access to exchange information with a user. Alternatively, a blacklist may be set up, such that members of Company A are not permitted to exchange information with the user through the application, perhaps because they are competitors or have some conflict of interest to share electronic information.

According to another exemplary limitation, a global positioning system (GPS) device of the phone may be used to locate the device of the user relative to other devices, and a distance range may be set production. This may also be done by other means, such as Wi-Fi, Bluetooth or other wireless communication standards or methods. Accordingly, a user may restrict a distance range to a few meters, in the case of a business meeting, to several hundred meters or more, in the case of a public event or concert, where a performer uses the application to simultaneously share information attendance of the concert, who may have access codes based on tickets that have been purchased.

The foregoing example implementations refer to an exchange of business cards. However, the present inventive concept is not limited thereto, and other example implementations may be provided to allow for exchange of other information. For example, but not by way of limitation, the information may be something other than identifying information of the user. Instead of a business card, the user may be providing advertisement information about a particular product, or a coupon to be redeemed at purchase, when the user is within the physical location of a store.

In other settings such as sports and entertainment, the application may be used to exchange information between a public figure such as an athlete or performer and his or her followers or fans. For example, if the application is used as a sporting event such that an athlete performs process for information exchange simultaneously with one or more other users, such as fans were spectators in the stadium, those spectators may receive a token, such as a baseball card, or a coupon to redeem the baseball card.

With regard to entertainment performers, a musician may use the application to exchange information with members of the audience at a concert, such that when the exchange occurs, a token such as a recording of a song or promotional information of the musician is provided to the users who participate in the information exchange protocol or custom by use of the application.

Accordingly, the concept of blacklists and whitelists can be applied to the foregoing settings. A user who follows a particular sports team or entertainer, or does not follow a particular sports team or entertainer, can generate an appropriate blacklist or whitelist to appropriately filter possible introduction information. Therefore, the user who is attending a sports event at the home stadium of an opposing team need not be concerned about receiving information of the opposing team, if he or she sets a blacklist for the opposing team, for example.

To implement the foregoing example implementations, the user may be provided with one or more settings that provide the necessary blacklisting, whitelisting, range of operation, or other limiting setting. For example, a user may set his or her application to a “Meeting” setting, such that the range of operation is 5 m or less, and the blacklisting or whitelisting of companies is implemented. Alternatively, the setting may be for “Seminar”, having a range of 100 m or less, and a less restrictive setting of blacklisting or whitelisting. In another implementation, the setting may be “Concert”, and the range setting may be set at a maximum or entirely eliminated, and the blacklisting or whitelisting may be set such that only entertainers, athletes, famous people or other limited users can interact with the application. The foregoing numerical ranges are examples, and other ranges as would be understood by those skilled in the art may be substituted therefor without departing from the scope of the inventive concept.

Such a setting could be enhanced, for example, to prevent other members of a fan club to have access to the application, or still further, the members of the fan club having other common user characteristics, such as same high school or university, or same hometown, or the like. Other levels of restriction, granularity and permission has would be understood in the art may be implemented by the application and/or the user.

Another setting that may be employed could involve the style of information exchange. For example, a formal exchange of business information requiring users to face one another and simulating the exchange of physical business cards may be set as a first macro, activated by the position of the thumbs at the corners of the touchscreen of the smart phone. Another setting may include the exchange of information in a more casual or less directly personal setting, such as a seminar or concert.

In such a situation, the user may set another gesture or series of gestures to indicate information exchange. Certain classes of information exchange gestures may develop for various types of events. For example, information exchange in a musical event may be invoked by the simulated plane of an instrument by the fingers on the touchscreen of the smart phone, or a sports related gesture for an athletic event to indicate exchange of information.

The trigger for information exchange may not be limited to touchscreen interaction, and may more broadly include, for example but not by way of limitation, camera that captures images or videos, audio input that captures voice or other sound information, or other identifying information.

In the foregoing example implementations, a user has a profile and settings. As explained above, the settings may include, but are not limited to, range limits, blacklists, playlists, macros on event type or meeting style or information exchange style, or privacy level. Additionally, the user has a basic profile, which includes the information to be exchanged, for example in a business card, as well as other information. The other information may include basic bibliographic information that is voluntarily provided by the user, such as a user identification or login name, payment for account information, interests, hobbies, preferences, associated other social network identification information, and contact information. The other social network information can be used to directly associate the social network user information of a first user and the second user who exchange information using the application porting to the present example implementation.

Thus, a user who completes the foregoing information exchange process may also, if they have appropriately set their user settings, exchange social network information, such as information of personal social networks or professional social networks. The level of privacy and exchange of information may be manually set by the user settings. Further, the user profile may be associated with the v-card information, for example.

In the foregoing example implementation, the interface provides an object to be activated, such as a toolbar or button bar, which includes a selection item that displays a list of other users who have the application currently open and are exchanging or available for exchange of information. If a user has his or her application on, and unless there is some other privacy restriction, such as a blacklist or whitelist, or range limit, the user may be displayed on the list of one or more of the other users.

When the list of other available users is displayed, the user is presented with the option of selecting one or more of the users for information exchange. Accordingly, the above described exchange of information in which a single user simultaneously exchanges business card information with a plurality of users may be accomplished by selecting one or more users, or a group of users.

The user interface also includes a timeline, such that the date of the meeting is shown, as well as the attendance, at any introductions or exchange of information that occurred on that date or at that meeting. An initial introduction or exchange of information may be shown by a different display, such as a photograph, whereas existing users who do not exchange any information may be displayed in another manner, such as without a photograph.

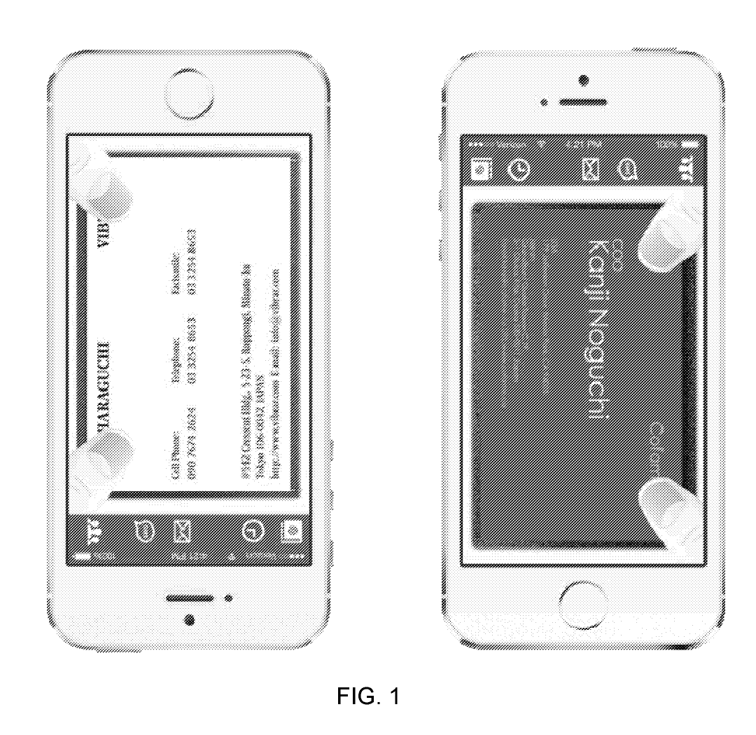

FIG. 1 illustrates a first process according the example implementation. As shown in FIG. 1, a first user and a second user have each placed their thumbs at the corner of the touch screen, so that the application can recognize that the users are in an information exchange mode. The contact information in the form of a business card image is displayed.

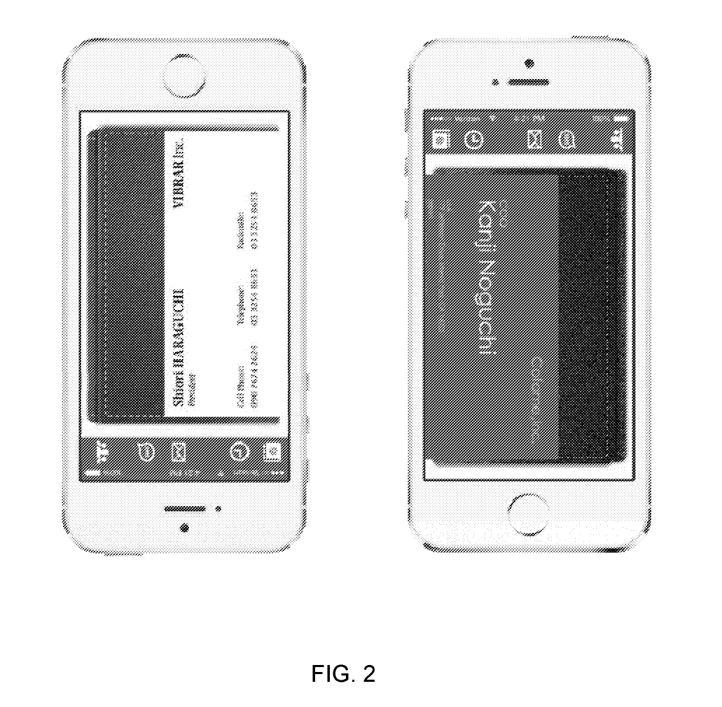

As shown in FIG. 2, the users each initiate the information exchange with one another by sliding the thumbs along the sides of the touchscreen. Accordingly, the image of the business card moves in an animated fashion away from the user and the other user. Behind the business card image, the cover of the business card holder or “skin” appears.

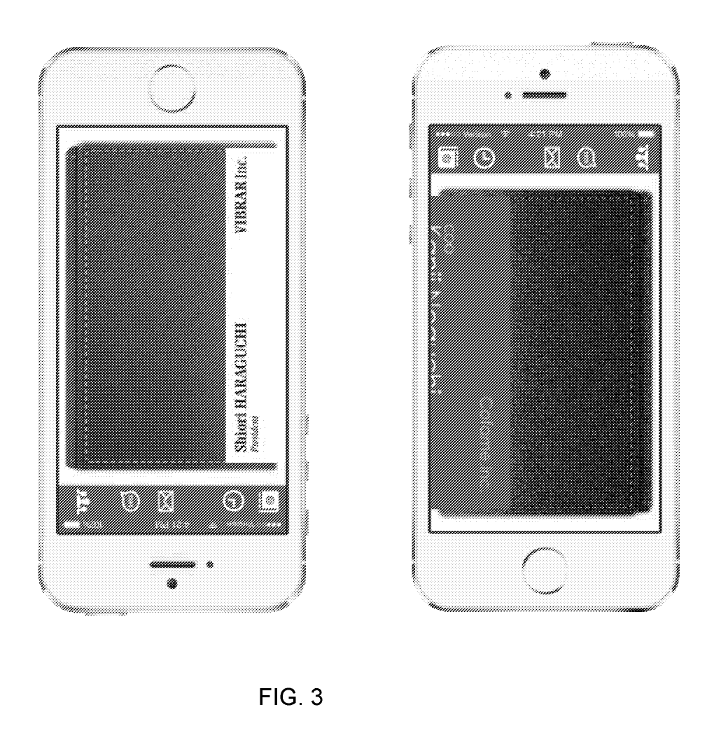

FIG. 3 illustrates a continuation of the information exchange process, as the business card of each user has almost completely moved off the screen based on the movement of the user's thumbs away from the user and along the edges of the touchscreen of the user's device.

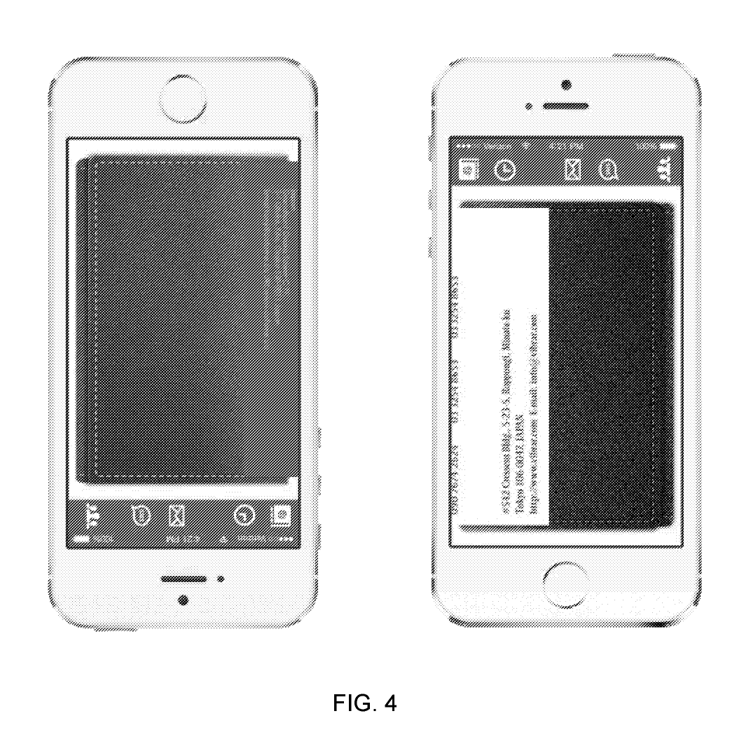

FIG. 4 illustrates the completion of the transmission aspect of the information exchange process as described in FIGS. 1-3 above, and the start of the acceptance or information receiving process. As can be seen in FIG. 4, each user is receiving the business card information of the other user, coming from the bottom of the card to the top of the card, so that the card is facing toward the receiving user, in contrast to the user's card facing away from the user during the transmission of the information in FIGS. 1-3.

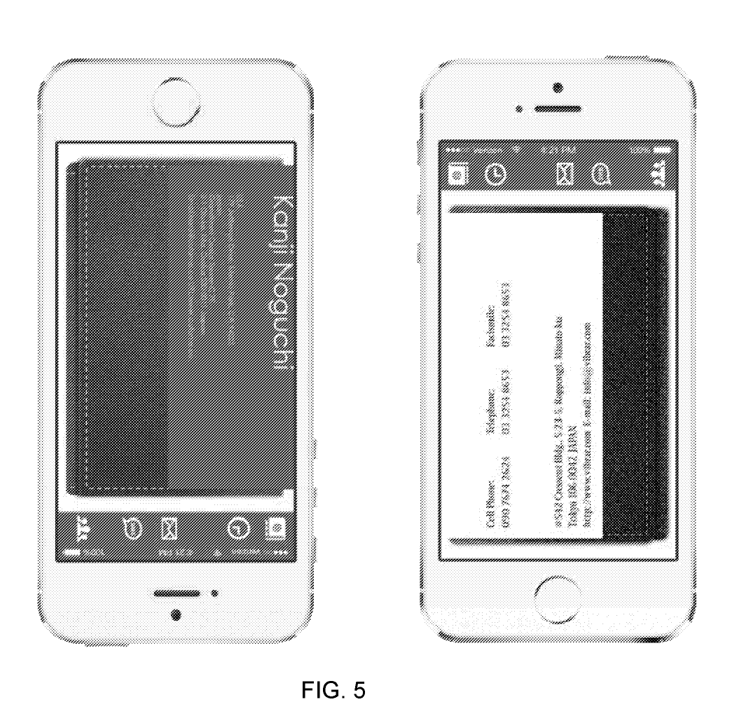

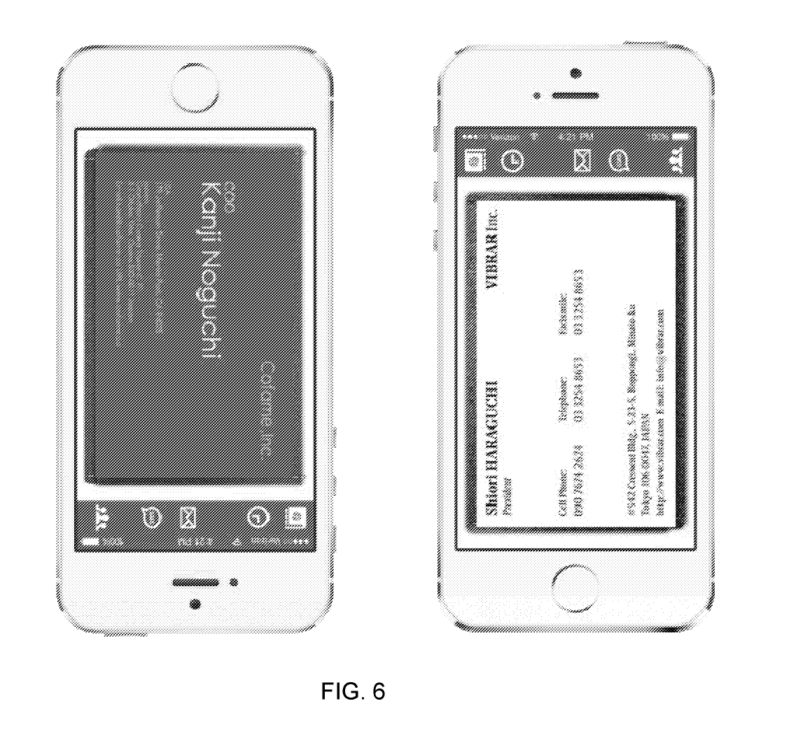

FIG. 5 illustrates a more advanced stage of the information receiving process, wherein the user is receiving the image of the business card of the other user. FIG. 6 illustrates the completion of the information receiving process, whereby the user has completely received the information of the other user.

According to a second example implementation, the user who has completed the information exchange process and has the information all other members in a meeting may access this information in a manner that is useful for the meeting itself. For example, but not by way of limitation, a user interface may display icons of all users having applications that accept information exchange with the user.

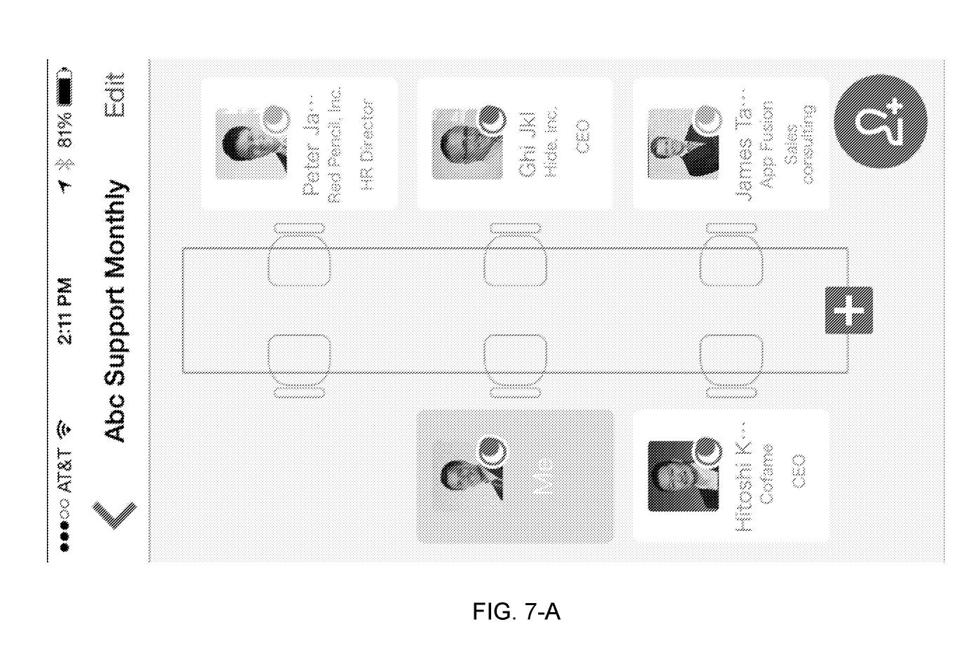

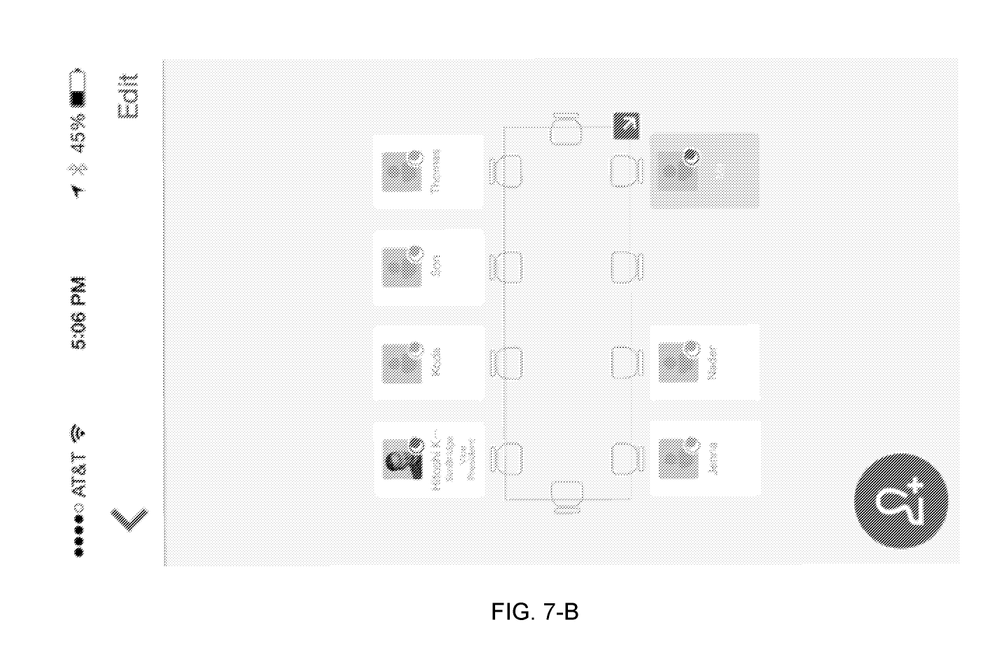

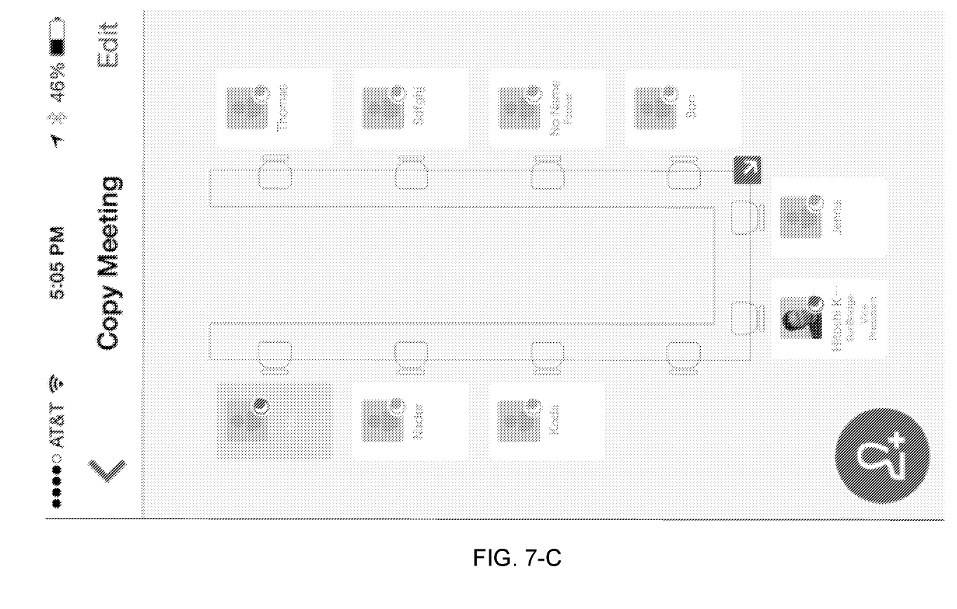

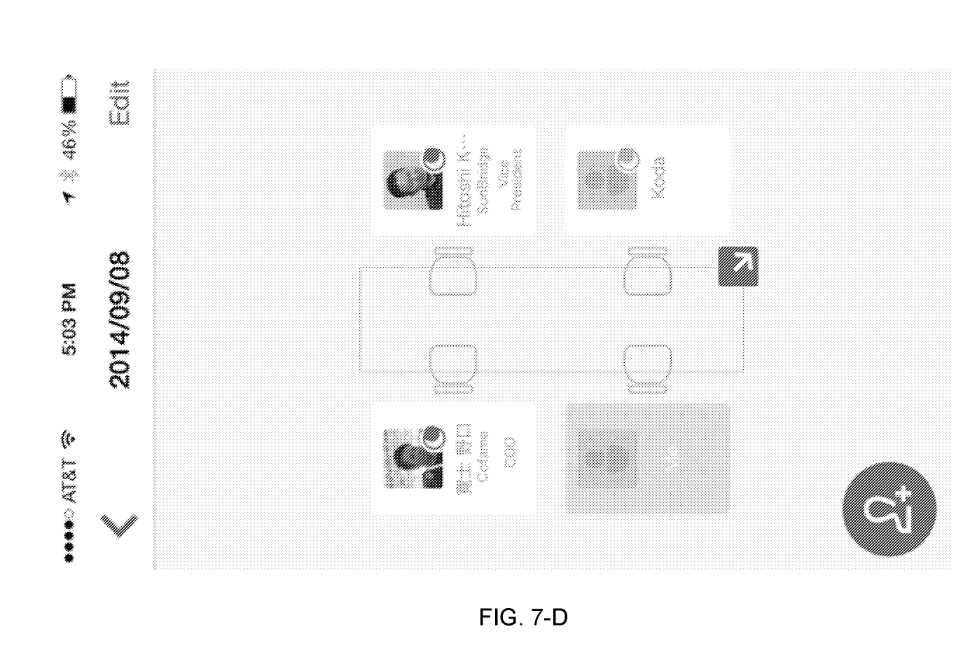

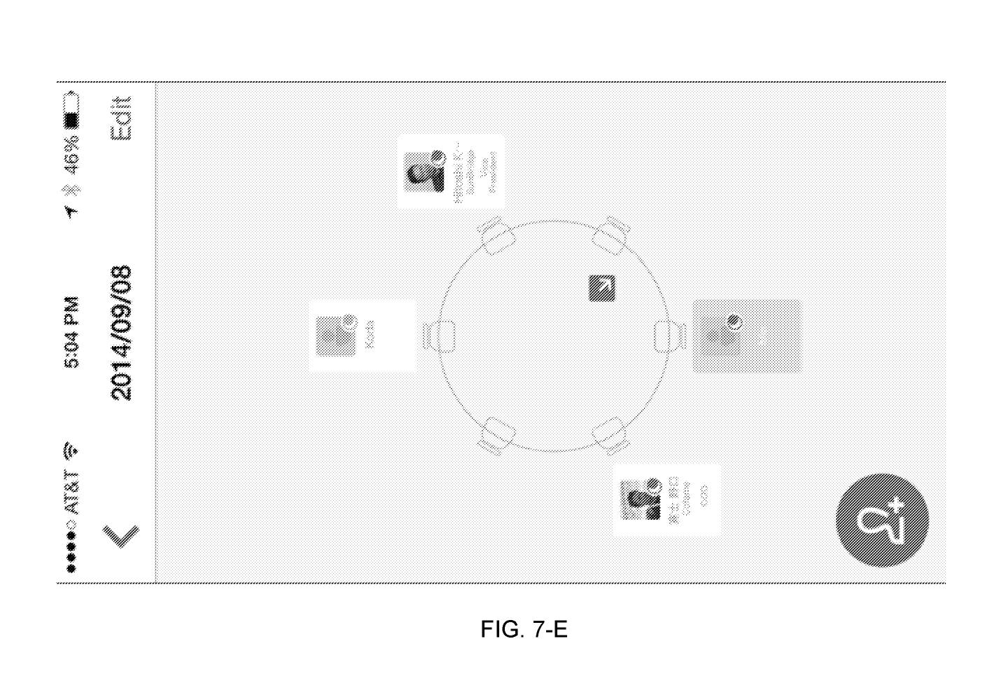

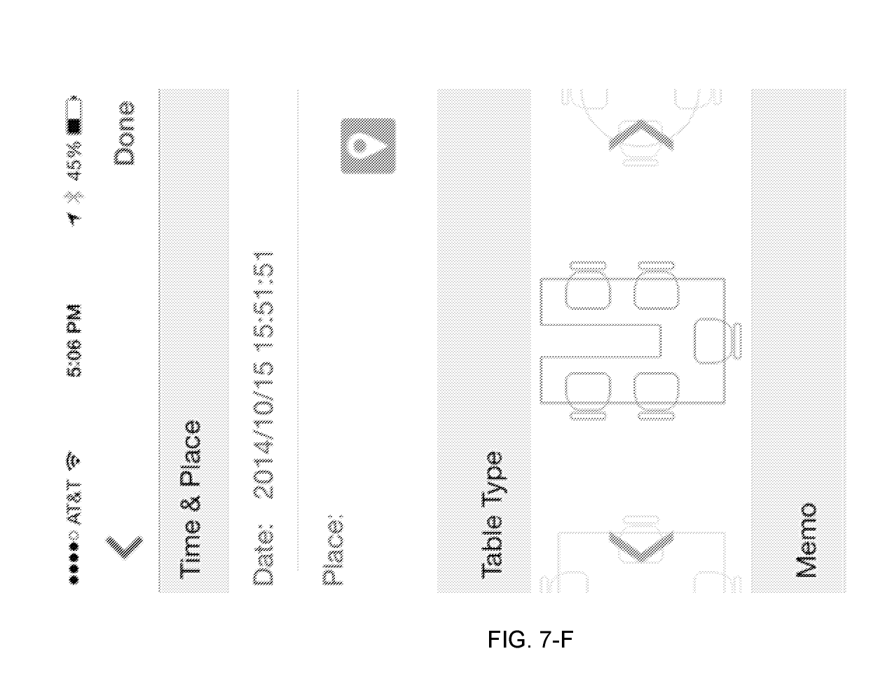

As illustrated in FIGS. 7-A to 7-E, the display may also provide relative physical location information, such as the relative seating arrangements at a meeting in conference room. A variety of seating configurations (such as those illustrated in each of FIGS. 7-A to 7-E) may be provided. For example, as shown in FIG. 7-A, an icon of the table having chairs is shown in the center of the user interface. The display associated with the present user is identified as “me”. Other meeting participants with whom the user has exchanged information as disclosed above and as illustrated in FIGS. 1-6 are shown at various positions on the user interface, which are associated with the seating positions at the table icon. The seating positions at the table icon are associated with the actual seating positions of participants of the meeting in the physical room in which the meeting is being held, and at that table.

For example, in FIG. 7-A, a schematic of a meeting table having a plurality of seats is shown. Icons are shown for occupied spaces in the meeting. Depending on the seating arrangement, a user may drag and move the icons to adjust for changes in the seating arrangements, for example. For each icon associated with a person in the face to face meeting, it is understood that the persons have performed an in-person exchange of business card information. Further, each of the meeting participants may optionally decide to have varying degrees of information displayed, such as photograph, name, title, company, contact information or other.

Although it is not shown in FIG. 7-A, relationships between meeting participants may be indicated (e.g., by lines and appropriate icons showing the identity of the social networking service. By use of differentiating indicators, such as color, line thickness, line width, texture or other indicia as would be understood by those skilled in the art, plural social networking services may be separately or concurrently shown on the display. Accordingly, the present invention allows for the display of social graph information associated with participants in a meeting, with the consent of those meeting participants who choose to permit such display.

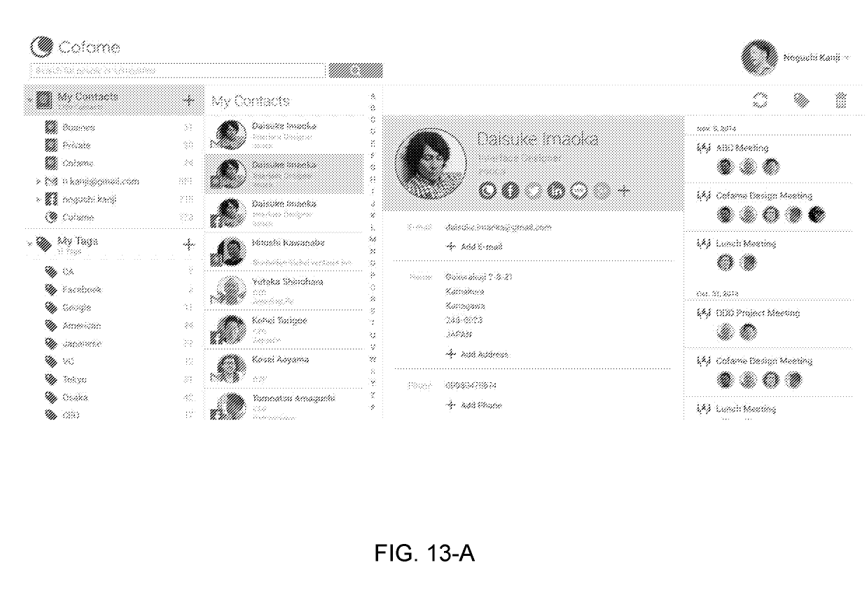

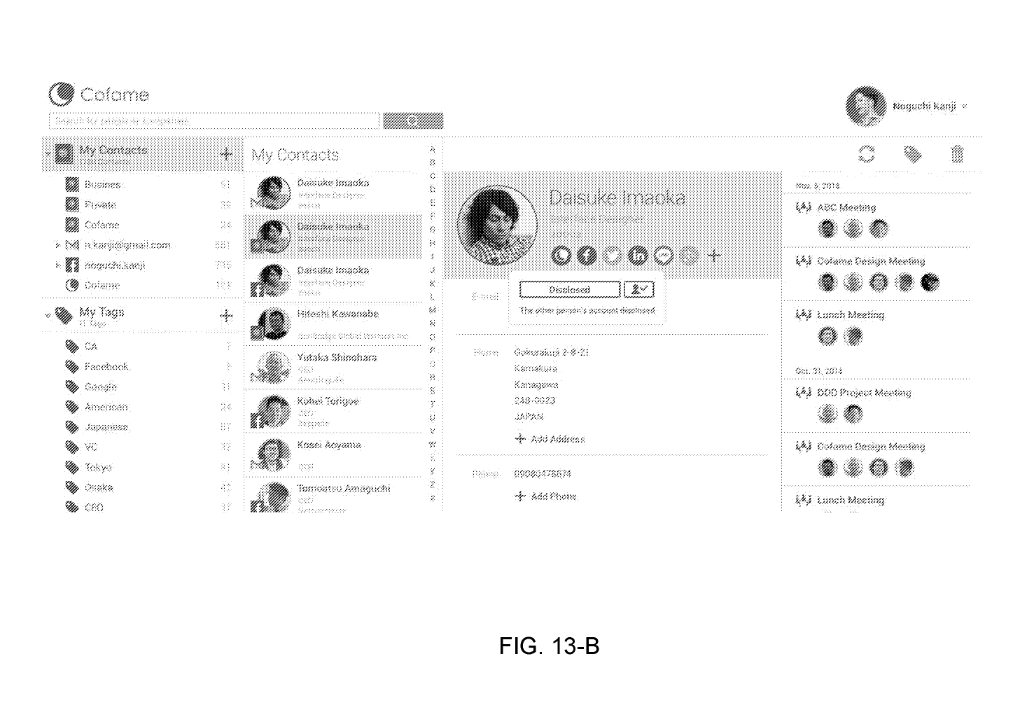

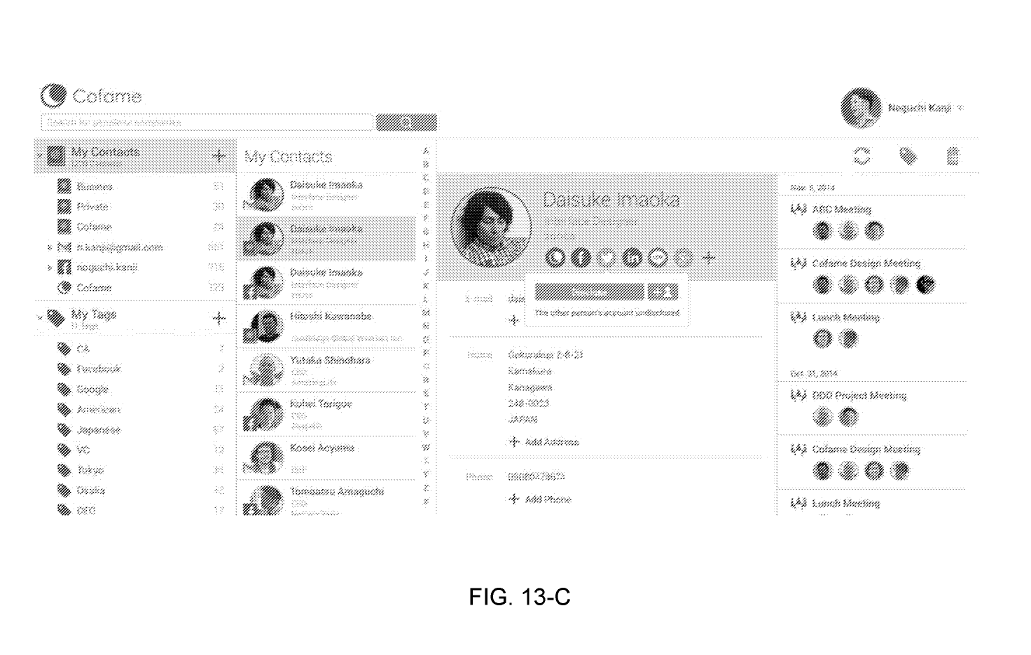

Meeting participants may be added, subtracted, changed, connected, or have other operation performed to indicate relevant content. If a meeting participant is specifically selected, the user may view an output similar to FIGS. 13-A to 13-C, for example, and be able to establish social networking service account information. If such information is established and social graph information viewing is permitted by the account holder, updated social graph information may appear on the interface of the one or more meeting participants in the manner explained above.

Alternatively, as shown in FIG. 7-B, the table size may be expanded, based on the actual number of participants the meeting. In this case, the icon of the table illustrates and chairs, indicating that there are 10 possible spaces for participants to set. Similar to FIG. 7-A, the user has his or her icon represented by “me”, and other users who have provided exchange information with the user as explained above are shown at their positions around the table icon on the interface, which reflects the actual seating positions of participants in the actual physical meeting room. As shown in FIG. 7-C, another table configuration is illustrated. Further, a “copy meeting” function is provided, such that the configuration can be copied and reused in other instances, or other meetings in the same room, for example.

FIGS. 7-D and 7-E illustrate additional different table configurations and shapes. FIG. 7-F illustrates the tool in the application that permits the user to of table format having various shapes and numbers of chairs in the icon. The user simply slides his or her finger along the user interface to scroll between different table types, and can select the table type depending on configuration of the actual physical room and number of chairs and the shape of the table. While a specific number of chairs is disclosed above, the present application is not limited thereto, and other shapes, sizes, numbers of chairs or other features of chairs may be incorporated, without departing from the scope of the present example implementation.

If such physical location information cannot be accurately provided, or if individual users associated with devices move within the meeting, the touchscreen interface permits the user to drag the icon associated with an individual to their new location. Further, a seating configuration selection screen may be provided to allow one of the variety of seating configurations to be selected using the touchscreen interface, as illustrated in FIG. 7-F.

By touching the icon, further information about other user can be shown, such as contact information, notes gathered by the user, or other relevant information for the meeting. According to one example of limitation, the icons are photo images of the other users, such that a user who may not recall the detailed information of a particular member who is joining a meeting can use the icon to access such information, without inconveniencing other users or embarrassing himself or herself. Thus, the meeting may be performed in a more efficient manner.

Further, a memo style user interface is available such that user may privately take notes during the meeting, and not have notes associated with meeting information that is exchanged with other users. The notes may be associated with the meeting information, or with one or more of the other users who were attending the meeting. Moreover, meeting attendants who are not using the application or who have not accessed the application may be manually added by the user. For example, if no other users have for providing access to the application, the meeting may be manually added to the timeline without performing the exchange of information via the application.

This example implementation is not limited to business meetings, and the user settings may be defined based on the type of event. For example, but not by way of limitation, the user settings may include a business meeting, a holiday party, a small social party, a wedding, or other event involving a plurality of users. The look and feel of the display may be adjusted based on the type of event, as well as the information to be displayed.

For example, the company and job title may be more prominently displayed in a business meeting type of event, whereas a social graph or information on the relationships of persons in a social party, wedding or other social event may be more prominently displayed for those types of events. As a result, the user can effectively receive the necessary information about other users based on the type of event. Similarly, the user can also provide appropriate information, and can control the access to various levels of information, depending on the type of event, or the type of user attempting to access the information through their application on the device.

Accordingly, the application may, with the consent of the user, collect and share information that is associated with business, social, shopping, hobbies or other aspects, via the social network of the user. Thus, relevant pattern information associated with the user may be provided and captured for more accurately determining the needs and interests of the user, and more accurately providing goods or services via a business or commerce partner.

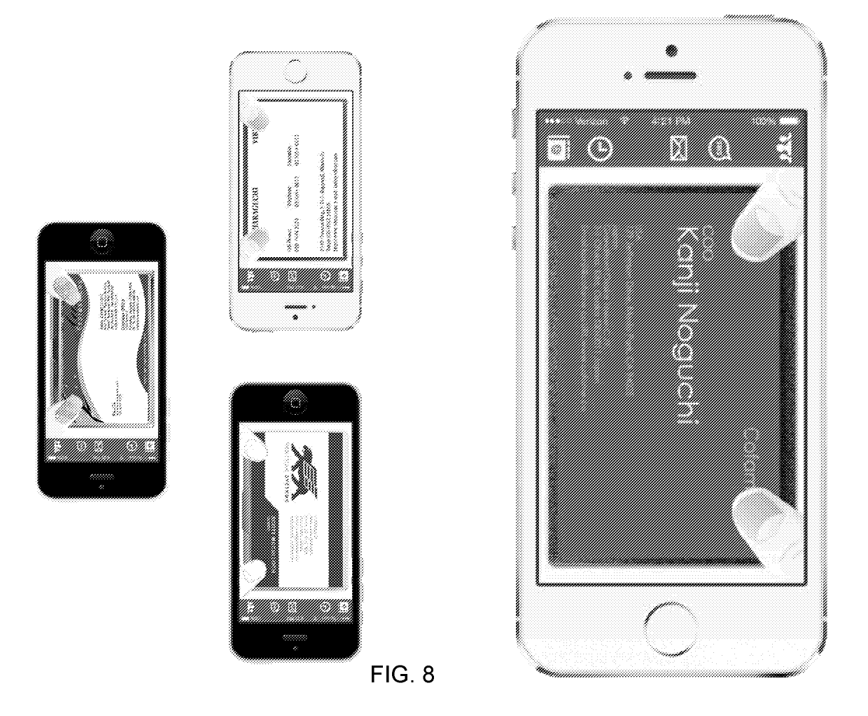

FIG. 8 illustrates a first process according to the second example implementation. According to this process. A plurality of participants in a meeting, such as a business meeting, are in a position to simultaneously exchange information. Accordingly, the process of FIGS. 1-6 is performed for the plurality of users. In the initial stage, the application is aware that the user may exchange information.

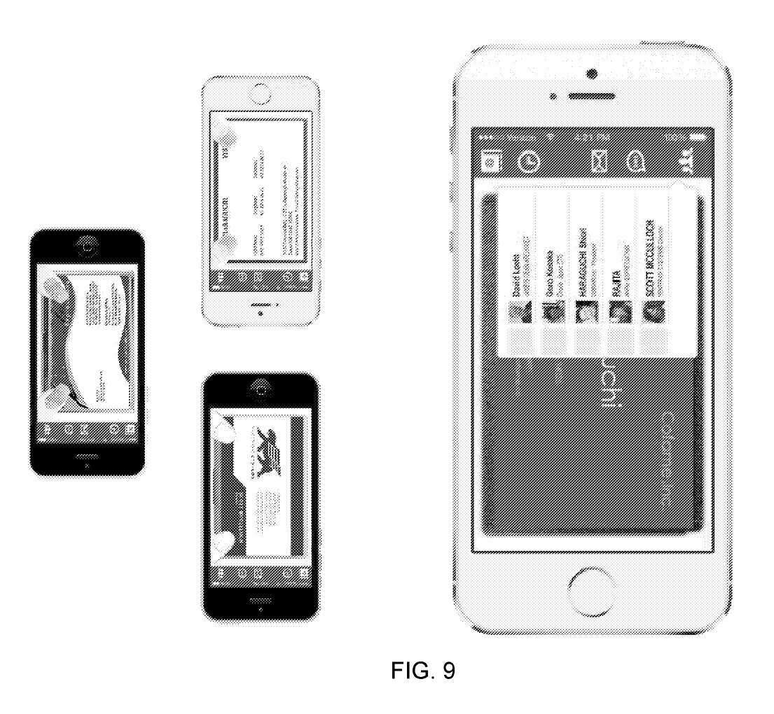

As shown in FIG. 9, a list of available users who are running the application and are in a mode to exchange information is displayed. In the present example implementation, for the user on the right, a pop-up list of five available users appears, and includes the three users on the right side of FIG. 9. Accordingly, the user (e.g., Noguchi) may choose one or more users with whom to simultaneously exchange information.

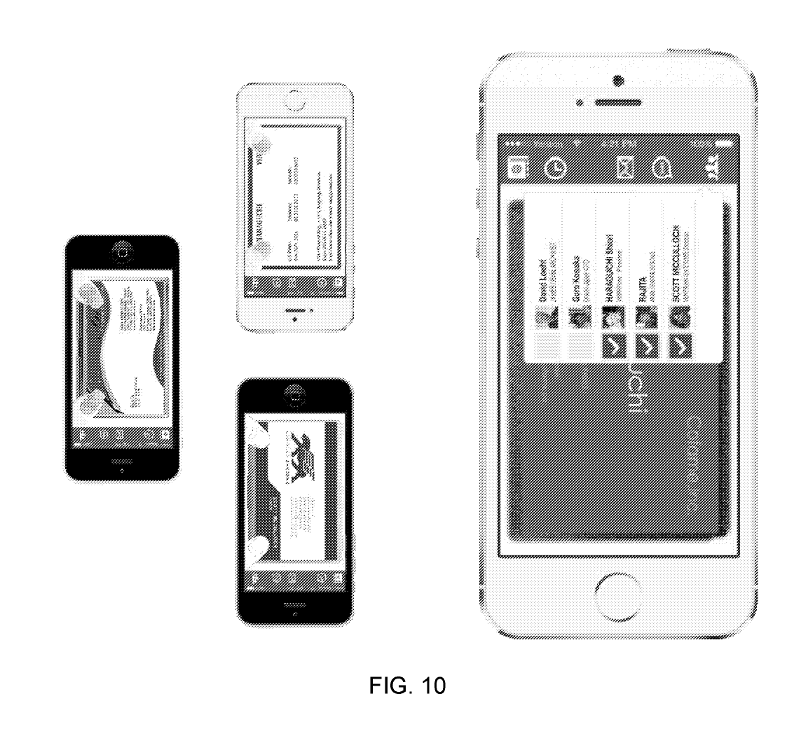

As shown in FIG. 10, the three users are chosen (e.g., HARAGUCHI, RAJITA, SCOTT . . . ), while two users from the list remain unchosen.

Accordingly, as explained above, the exchange proceeds in a manner similar to that shown in FIGS. 1-6, except with multiple users.

FIG. 11 illustrates the selection of the timeline feature after the information exchange of FIGS. 8-10. For example, as shown in the left side, the user may select a timeline function from a toolbar, and the timeline on the right side of FIG. 11. The meetings of that date are shown, along with the participants of the meeting. Groups or other organizations of individuals may also be added to the list, for ease of organization and/or viewing.

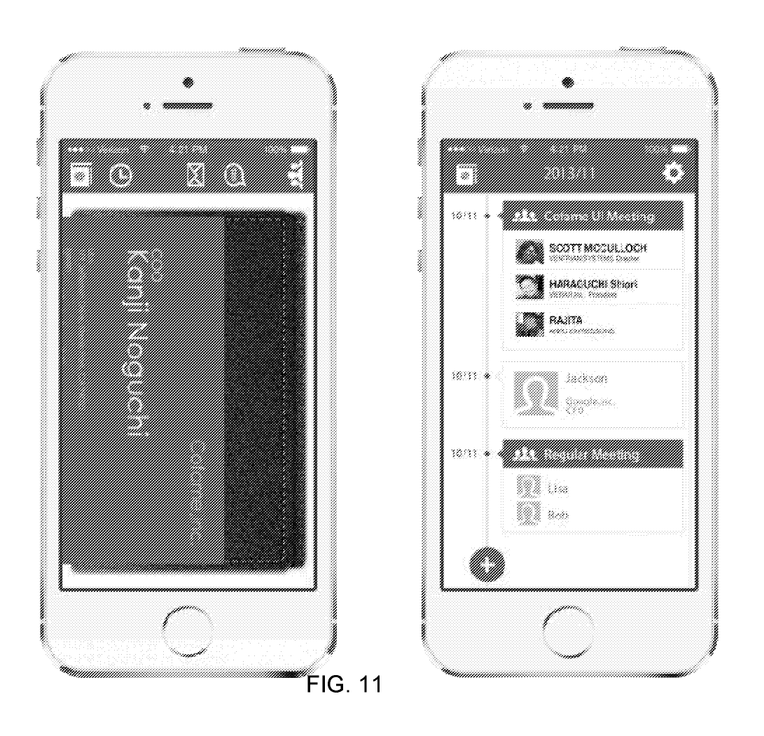

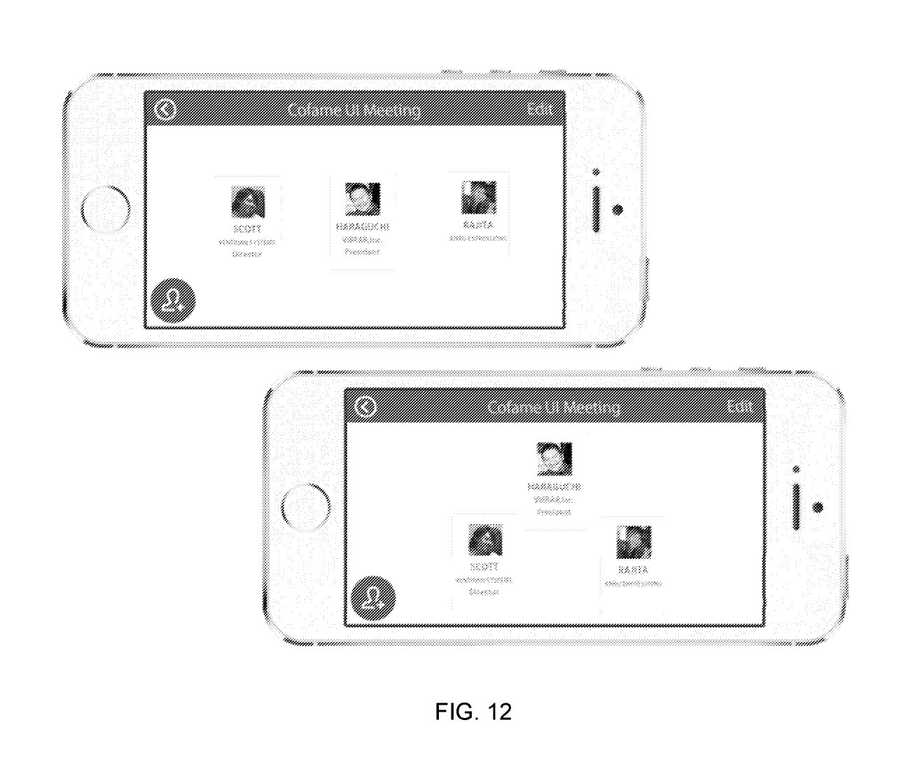

FIG. 12 illustrates the meeting mode according to the second example implementation. More specifically, between the upper and lower illustration, the icons associated with each of the meeting participants are displayed, including photo image, company name, and title for example (although not limited thereto). The user can drag and drop the icon associated with the meeting participants to reflect the actual configuration of participants, for example at a table in the room.

According to the foregoing example implementation, information of the one or more meeting participants may be provided to a user of the application, where the meeting participant has consented to share such information. The information may include such information as, but not limited to, the name, the organizational rank or title, the organization (e.g., employer or representative associate), the contact information, (e.g., telephone number, facsimile number, e-mail address or other directed contact information), and visual information such as an image, icon or photograph.

As a result of the visual information, the user may be able to associate the appearance of the meeting participant with the name, and easily introduce himself or herself to the meeting participant, without having to research or guess at the name or related information of the meeting participant. As a result of this feature, the user may avoid inconvenience, confusion, delay or embarrassment associated with not being able to immediately recall or introduce himself or herself to the meeting participant.

Further, the information may include, but is not limited to, social graph information of one or more of the meeting participants. For example, but not by way of limitation, the information of a meeting participant that is displayed to the user may provide information associated with the social networking services to which the meeting participant has subscribed, where the meeting participant has consented to share such information. For example, a meeting participant may have a membership in a social networking service (e.g., LinkedIn, Facebook Twitter, or the like).

By showing an icon or other display information that indicates the meeting participant's membership in the social networking service, the user can easily determine the activity of the participant in one or more social networking services, where the meeting participant has consented to share such information. Further, the user may be able to view the social network service profile of the meeting participant, where the meeting participant has consented to share such information.

For example, if the meeting participant is a member of a social networking service such as LinkedIn, the user may access the LinkedIn profile of the meeting participant, and may attempt to perform available functions on the LinkedIn social networking service, such as sending a direct communication, inviting the meeting participant to connect to the user, or posting content and suggesting the content to the meeting participant, where the meeting participant has consented to share such information. The meeting participant may consent to none, some or all of the social networking services with which he or she has an account.

As a result, the user does not need to perform an extra search to determine whether the meeting participant is a member in the social networking service, because that information will immediately appear as shown in FIGS. 13-A to 13-C.

For example, FIG. 13-A illustrates an example user interface associated with the application. According to the example of FIG. 13-A, a user may access the application via the user interface, which may be a non-mobile device user terminal, such as a tablet, phablet, laptop, desktop computer or other display configured to output the display of FIG. 13-A.

In the present example implementation, the user (e.g., Noguchi Kanji), has received information of a meeting participant (e.g., Daisuke Imaoka). The user is provided with the name, title and company of the meeting participant. Further contact information may be provided with the consent of the user, including but not limited to address, email address, telephone contact, or other. Further, the user is provided with icons that are indicative of the social networking services with which the meeting participant may have an account. For example, the user may have an account with the icons that are displayed as being active (e.g., color), and may either not have an account or have not granted permission to display to the user the account association for icons that are displayed as inactive (e.g., grayscale). In the present example implementation, the application indicates that the meeting participant is displaying that he or she has an account with the application (e.g., Cofame), Facebook, LinkedIn and SMS, whereas no such indication is given for Twitter and G+.

As shown in FIG. 13-B, if the user selects an icon of an account of the meeting participant that is indicative of the social networking service information being disclosed, a popup or other display is provided for the user to invite the meeting participant to connect via the social network account. For example, the user may send an invitation for the user to connect to Facebook, LinkedIn, or SMS. Under such a circumstance, the meeting participant will receive an invitation, either in the application used to exchange the business card information (e.g., automatically) such that the meeting participant can accept the invitation via the application, and not have to go directly into the native interface of the social networking service. Moreover, the native interface of the social networking service would not even permit the user and the meeting participant to connect if the user or meeting participant had a profile that was not public at all, such that the user could not determine the account information of the meeting participant, or vice versa. Accordingly, the present application permits the user and the meeting participant, who have introduced and exchanged business card information via the application as explained above, to connect accounts on social networking services via the application, in situations where the native social networking service application would not permit such connections.

Similarly, if the user is already connected to the meeting participant, then such an association is displayed.

Alternatively, as shown in FIG. 13-C, if the user and meeting participant are not sharing account information of the social network service (e.g., Twitter or the like), the user may be provided with such an indication when they attempt to access the icon. In such a situation, the user may offer to disclose her or her account status to the meeting participant. The user will still not be provided with the account information of the meeting participant unless the meeting participants chooses to provide this information; however, the user can make his or her account presence known to the user without having the account information of the meeting participant.

Similarly, the user need not search for the membership information of the participant, because such information, as well as available functions on the social networking service, can be accessed by selecting (e.g., tapping or clicking, but not limited thereto) the indicator or icon associating the member with the social networking service.

Accordingly, the user and the meeting participant can exchange contact information as explained above, and also immediately connect with one another's social networking service once the exchange has occurred, where the meeting participant has consented to share such information. For example, the user and the meeting participant may introduce or meet for the first time, and electronically exchange contact information in the form of the electronic business cards, as described above. Once the exchange has occurred, the social networking service information of the user immediately appears on the interface, where the meeting participant has consented to share such information. Thus, the user can connect via LinkedIn, Facebook, or other social networking service immediately, where the meeting participant has consented to share such information. Thus, the user and the meeting participant become connected in one another's social graph, without requiring manual determination as to whether the meeting participant is a member of the social networking service, and searching for the contact information, where the meeting participant has consented to share such information. Further, the risk of manually sending an invite in error to a person with the same name in the social networking service is also avoided. Similarly, the meeting participant may initiate the process, such that the user receives an invitation to join the meeting participant's social network, once the parties have exchanged electronic business cards.

As another option, the application may be set so that an invitation to connect via social networking service is automatically sent without any user or meeting participant intervention, when the electronic business card exchange occurs. Similarly, an invitation to connect on the social networking service can automatically be accepted by use of the application, if it is known that the invitation to connect on the social networking service has been sent due to the electronic business card exchange. As a result, a user and a meeting participant can seamlessly connect to one another on a social networking service when exchanging the electronic business card information, where the meeting participant has consented to share such information.

According to another example implementation, in a meeting with a plurality of participants, the social graph information of each of the meeting participants, including whether the meeting participants are connected to one another on a social networking service, can be displayed to a user, where the meeting participant(s) has consented to share such information. The display can be toggled between various social networking services. For example, but not by way of limitation, a user can view a chart of members in a meeting room sitting around a table, on a mobile computing device. When the user selects a social networking service (e.g., LinkedIn), the social graph will be presented to the user, showing connections between the meeting participants (e.g., by lines or links), and showing common groups, memberships, organizations, or the like. The user can toggle to another social networking service (e.g., Facebook) and show similar connections.

In an alternate example implementation, the social networking services may be viewed together (e.g., using different colors, shapes or other indicia). As a result, the social graph information of the meeting participants on various social networks may be overlaid, so that the user, who is also a meeting participant, can view the various social graphs and the extent of relationship between various meeting participants, where the meeting participant has consented to share such information, where the meeting participant(s) has consented to share such information.

For example, a user may be able to see the extent of the social graph relationship between meeting participants who are members of the user's company, where the meeting participant has consented to share such information. Thus, the user may be able to better understand the relationships between the members of the user's company, where the meeting participant has consented to share such information. Similarly, the user may be able to understand the relationships between the members of the other company, or between members of the other company and the user's company, where the meeting participant has consented to share such information.

In other settings involving a larger number of meeting participants, the information can be used to better understand or model behavior or participation at events. For example, at a sporting event or a concert, an announcement may be made to exchange contact information at a given time, or using a given protocol, so as to “follow”, “like” or “connect” with the sports team, an entertainer, company or other entity, where the participant has consented to share such information. The event organizer may be thus able to understand the social graph of the users who are attending the event, and also, to push information to those users at that event (e.g., parking information, product purchase information, or the like). Similarly, users who meet at such events can easily connect to the social graphs of one another, where the each user has consented to share such information with one or more other users.

With respect to the foregoing, the granting of such access with consent is provided, even in cases where the participant does not have a publicly available account on the social network service. For example, a meeting participant may have no public account information on LinkedIn can be viewed by the general public, and the meeting participant has an account, but that account information can only be viewed by other members within the private social network of the meeting participant on the social network service. The present application permits the user, who is not already known to the meeting participant, to access such information through the application only. The user can view on his or her application whether this is being done, and the actual status of the connection.

The user may be able to view icons associated with one or more of the various social network services of the meeting participant. The meeting participant may choose to not allow the user to view the connection status. For example, the connection status of the meeting participant for LinkedIn and Facebook may be provided, whereas the connection status for Twitter or Google+ may be not shown, due to a user preference to only show the availability of certain social networking services. The social networking service does not provide the user with any recommendation or “push” the name of the meeting participant to the user, based on any other criteria, because in the social networking service, the meeting participant may have maintained a non-public profile.

If the meeting participant has chosen to disclose status information to the user for a social networking service, the application may automatically associate the account of the user and the account of the meeting participant on the social networking service. Alternatively, the user and the meeting participant may attempt to connect via the social networking service itself, outside of the application, by taking additional steps. However, by using the application, the need for taking additional steps can be avoided, and in the context of a meeting, such connections can be made with relative speed and ease.

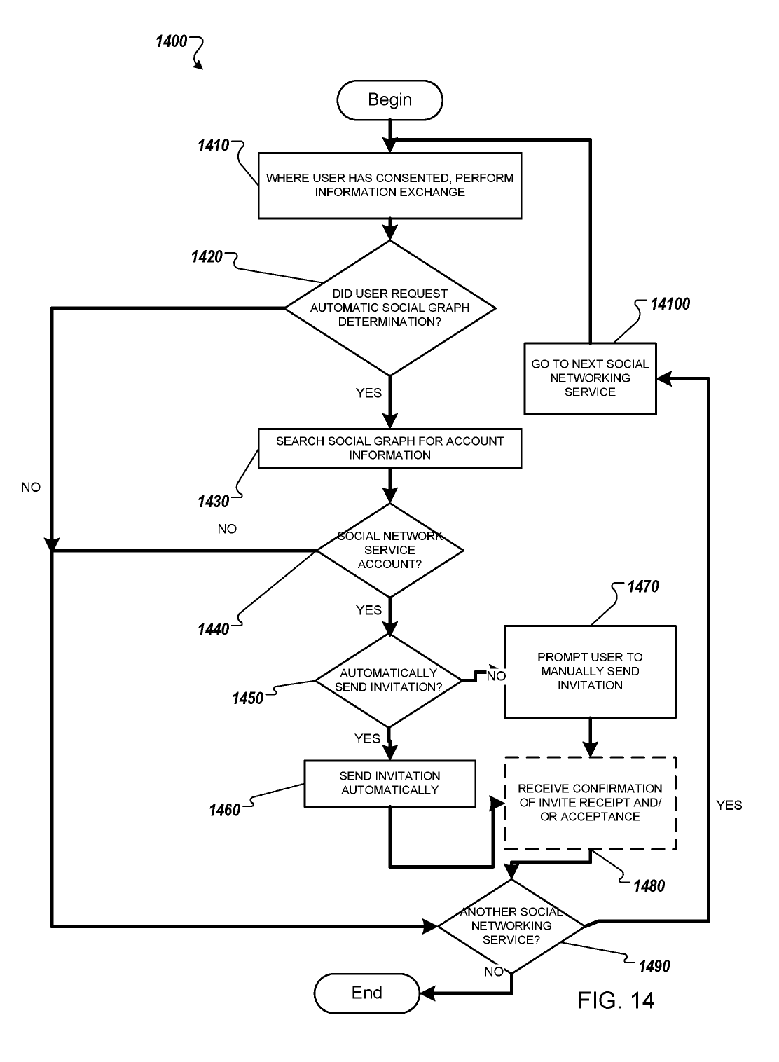

If a meeting participant has chosen to not disclose their account information or may not even have an account, whereas the user has an account on the social networking service, the user may choose to invite the meeting participant to connect, or to join the social networking service. This is shown in FIGS. 13-A to 13-C, for example. The disclosures of FIGS. 13-A to 13-C are explained below, and in reference to FIG. 14.

The decision of a user or a meeting participant to share social networking service account information can be accomplished by using the account settings of the application. For example, the application may prompt a user to select one or more social network services to activate for viewability and connectability by other members having accounts with the application. Thus, the application may permit the user and the meeting participant to connect with one another at the level of the social network service, in a manner that would not have been possible for the social network service account settings of the user and the meeting participant. This availability may only be available once the user and the meeting participant have exchanged their electronic business card (e.g., contact) information via the application an in-person in face to face meeting.

The requirement by the application of a face to face meeting or an in-person meeting allows both the user and the meeting participant to have another manner of validation and verification of the identity of the parties. Further, the application provides a scheme for distinguishing or filtering connections that have been made on an in-person basis, from those connections that are made through remote online contact between users having online social network service accounts, but who may have never met before in person.

Once there has been consent from both the user and the meeting participant, and the meeting participant agrees to associate his or her account with the account of the user on the social network service, then the accounts are connected. Because the account identification is already known for the user of the application, the application must obtain and access the account identification of the meeting participant, which is also made available to the application by the meeting participant, for example, in the account settings, as described above.

Further, plural social networking services may be provided to the meeting participant and the user, who are both participating in the meeting. Thus, the parties can receive and review the information of plural social networking services, with the consent of the account owners.

For example, the application may login to the social networking service as the user or the meeting participant, and send the request automatically on behalf of the user to the meeting participant, or vice versa. Therefore, the application sends the invitation on behalf of the user to the meeting participant. This is accomplished by the user of an application programming interface (API), which performs the invitation and acceptance on behalf of the parties. The party receiving the invitation may accept the invitation via the application, and not be required to directly access the native application of the social networking service. Those skilled in the art would know how to develop and implement the API.

With respect to the obtaining of the data and the account information, well-known application programming interfaces (API's) may be used in conjunction with the application. For example, but not by way of limitation, the application may be set to allow user to access the social network account while logged into the application, without accessing the native user interface of the social network account. Similarly, the application permits for the user to determine whether and how much account information to provide to other users of the application. A user may access this information via the account settings, for example, and may change the settings at any time.

Further, if the user knows the account information of another user, then a request to connect the accounts of the social networking services can be sent via the application, without having to go to access the social networking application. This is also accomplished via a standard API. Once the connection has been established between the accounts of the social networking service, the application will maintain and update this information, subject to the control of the user.

For example, the collection of data from third party services, such as LinkedIn and Facebook, is described as noted below.

There are two parts of technology used, (1) account information of Social Network, and (2) making connection/approve on specific Social Network.

For (1), the application allows the First user to set which Social Network account will send to Second user. At the same time, the Second user can also adopt similar settings. That information is only for account names of social network, and each user can change it anytime, and the information is immediately updated on the system.

For (2), if one knows opposite's Social Network account name, the user can send a request for connection on the Social Network over API. Each API is ‘generally’ provided by each Social Network Service, e.g. Facebook, LinkedIn. The application may be able to add any service if the vendor provide these APIs. Once connected, the application maintains the status and performs updates as necessary.

FIG. 14 illustrates a process 1400 according to the foregoing example implantation. At 1410, the user and the meeting participant exchange electronic business card information, with the consent of the user. At 1420, the application determines whether the user has requested to automatically determine the social graph of the meeting participant. If the answer is “yes”, the social graph is searched at 1430 for the account information of the meeting participant. If the answer is “no”, the process goes to 1490 as explained below.

If the answer of 1420 is “yes”, as noted above, at 1440 the application determines whether the meeting participant has an account or membership in the social network service. If the answer is “yes”, at 1450 the application determines whether user wishes to automatically exchange social networking service information with the meeting participant. If the answer is “no”, then the process goes to 1490 as explained below, as the meeting participant is not a member of the social networking service.

If the answer is “yes”, at 1460, the application automatically sends an invite to the meeting participant. If the answer is “no”, at 1470, the application prompts the user to determine whether to manually send an invitation to connect with the social network of the meeting participant. At 1480, the user may optionally receive a confirmation of connection to the meeting participant.

As shown in 1490, the application determines whether there are additional social networking services to consider. If the answer is “no”, the process terminates. If the answer is “yes”, at 14100, the social networking service is updated and the process continues as explained above. Further, the foregoing process may be replicated in sequence or in parallel for each social networking service of which the user is a member, for each meeting participant that the user meets.

In order for the foregoing example implementations to be executed, the membership information of the social networking service must be integrated with the information of the electronic business card exchange service. For example, thus may be done by integration between these services, by manual request for permission, or other manner of obtaining and sharing information between social networking services, as is understood by those skilled in the art. The application then selectively displays the social network service information as noted above.

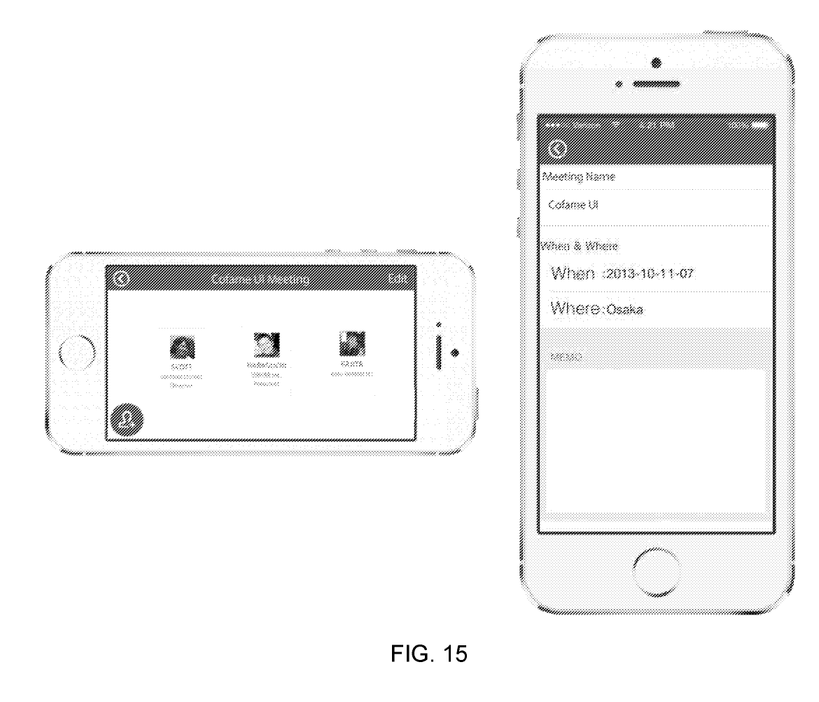

FIG. 15 illustrates the above-discussed memo function, where the user can take a memo of the meeting.

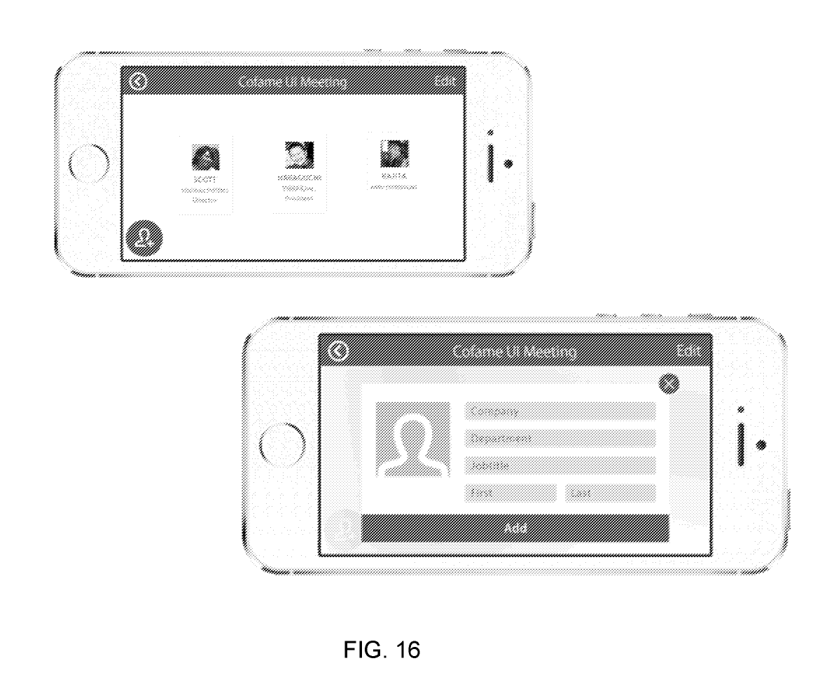

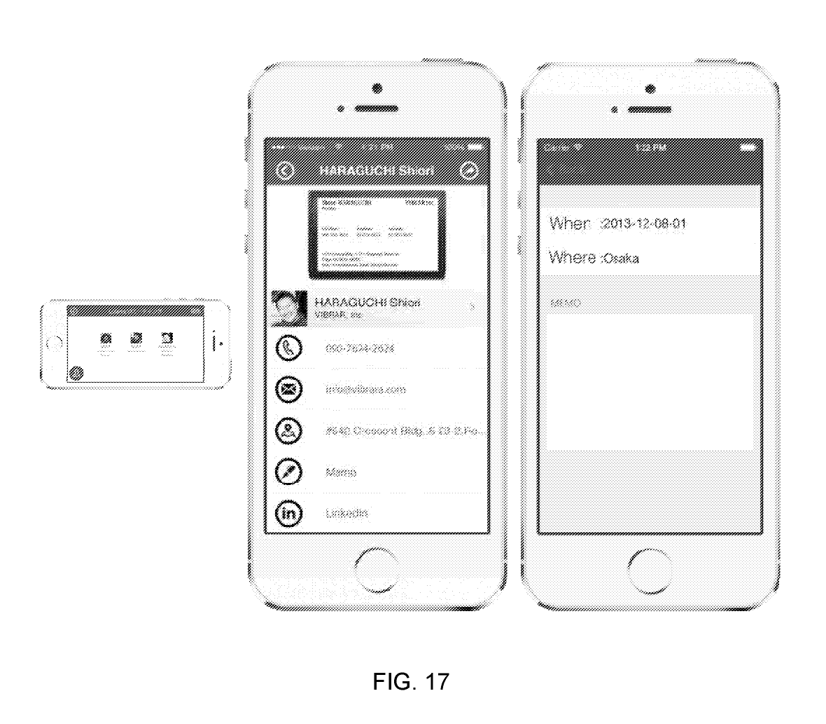

As shown in FIG. 16 and as described above, meeting participants who do not have the application installed may be manually added by the user having the application. As shown in FIG. 17, notes may be taken that are associated with the individual, and not the meeting as a whole.

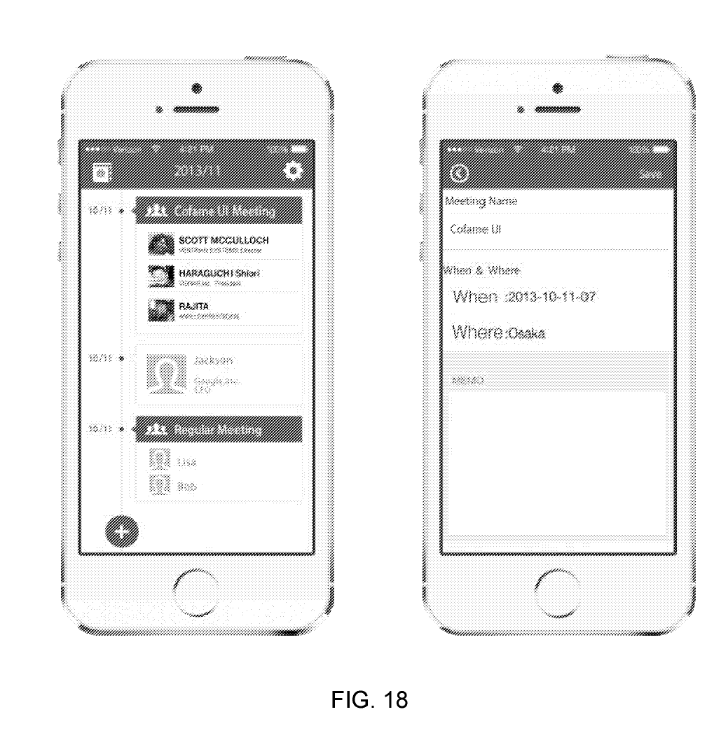

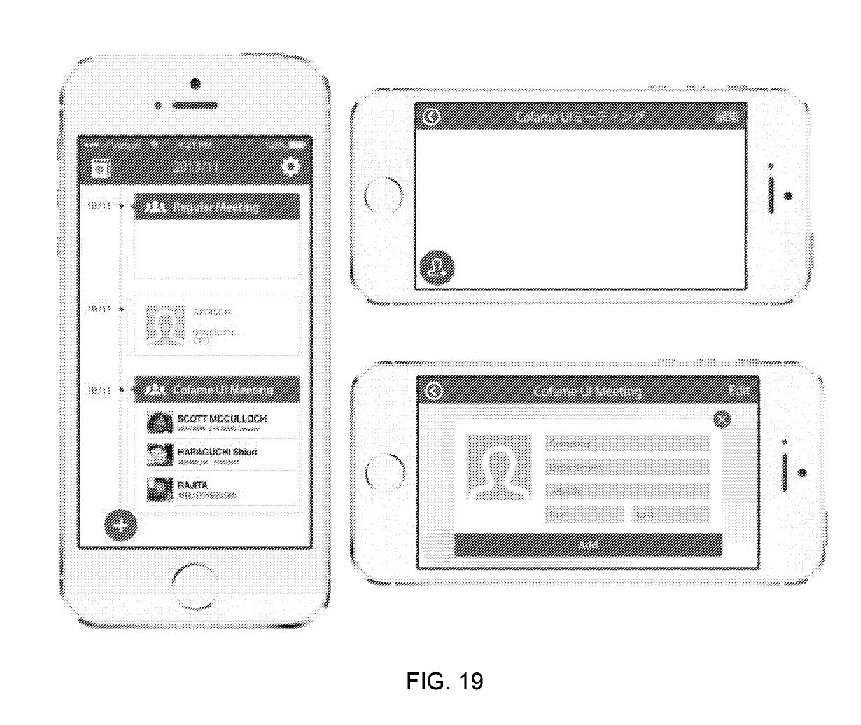

As shown in FIG. 18, a meeting can also be manually created without using the application for the information exchange. More specifically, the “+” object (e.g., button) can be used to create the meeting and enter the information of the meeting participants, and any other relevant meeting information. As shown in FIG. 19, once the meeting has been created, it will appear in the timeline.

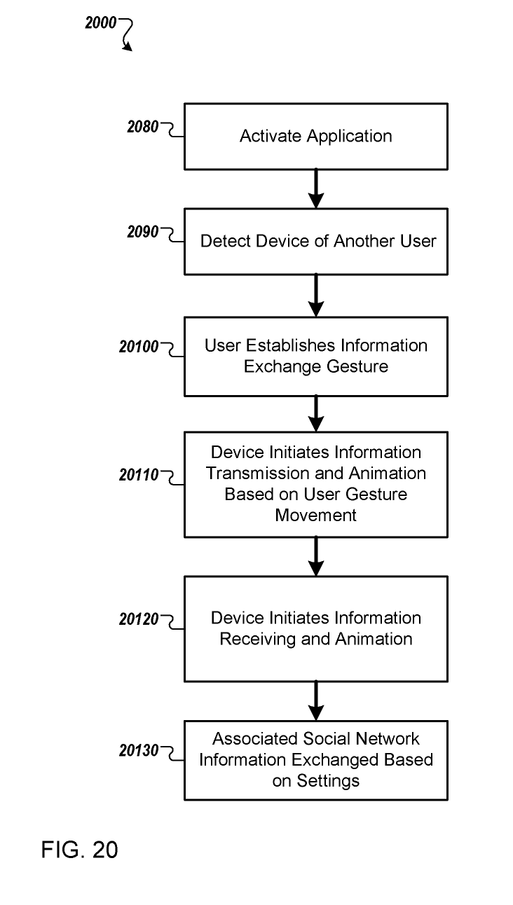

FIG. 20 illustrates a flowchart for a process 2000 of the exchange of information according to the first example implementation. At 2080, the user starts the application, for example, by actively selecting the application, or setting the application to run in the background while smartphone is in operation.

At 2090, the device of the user detects at least one other device associated with another user. For example, as explained above, the device detection can be used on a device identification via Bluetooth, Wi-Fi, 3G, LTE, or other communication method or standard.

At 20100, once the detection has occurred, the user establishes an information exchange gesture. For example, as disclosed above, the gesture may involve the thumbs of the user positioned at the corner of the touchscreen.

At 20110, based on the user gesture movement (e.g., sliding of the thumbs on the touchscreen of the smartphone device, as explained above), the device initiates information transmission. Further, the animation of the business card information in a direction away from the user is also disclosed.

At 20120, once the animation indicative of information transmission has been completed, an animation indicative of receiving the information of the other user is implemented. It should be noted that while the transmission and receiving animations appear sequentially, the transmission and/or reception of information may be an integrated process, and need not be sequential in nature.

At 20130, once the information is fully exchanged, the shared information may also be propagated to professional and/or personal social networks, depending on the user's privacy settings.

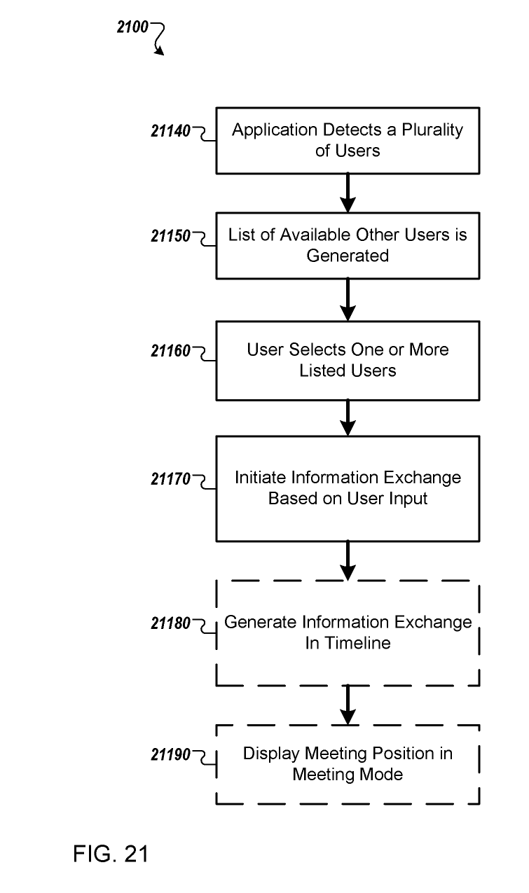

FIG. 21 illustrates a flowchart for a process 2100 of the organization of information according to the second example implementation. As shown in 21140, the application detects the devices associated with a plurality of other users, and determines which devices are running the application and are available for information exchange.

As shown in 21150, a list of the other available users is generated. For example, the other users with whom the user may exchange information is generated. In 21160, the user selects one or more other users from the list for exchanging the information.

In 21170, the information is exchanged in a process similar to FIGS. 1-6 and FIG. 20, as explained above. At 21180, optionally, the information may be associated with a timeline, and at 21190, optionally, the information may be associated with display of a meeting position in a meeting mode.

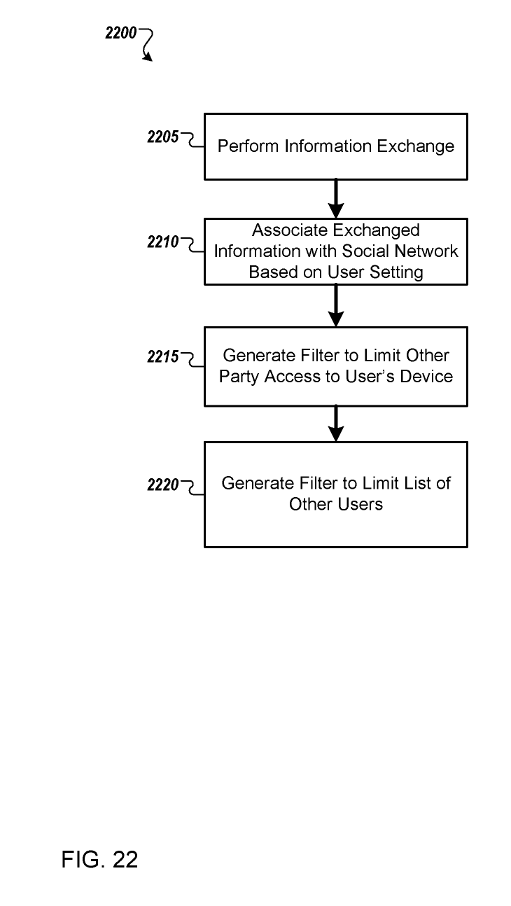

FIG. 22 illustrates a flowchart for the sharing and filtering of information according to another example implementation. As shown in 2205, the information exchange as described above with respect to FIG. 20 is performed. In 2210, the exchanged information is associated with a professional and/or personal social network, based on the privacy settings of the user. At 2215, the user limits access by other parties to the user's information, by either turning off the device or application, or by adjusting a user setting to not permit access except by whitelist or blacklist, or range limitation, for example. The user may invoke macros, as explained above. At 2220, the user may limit the other users who appear on the user's list of available other users with whom to associate. Based on this information, sharing and filtering of information is performed.

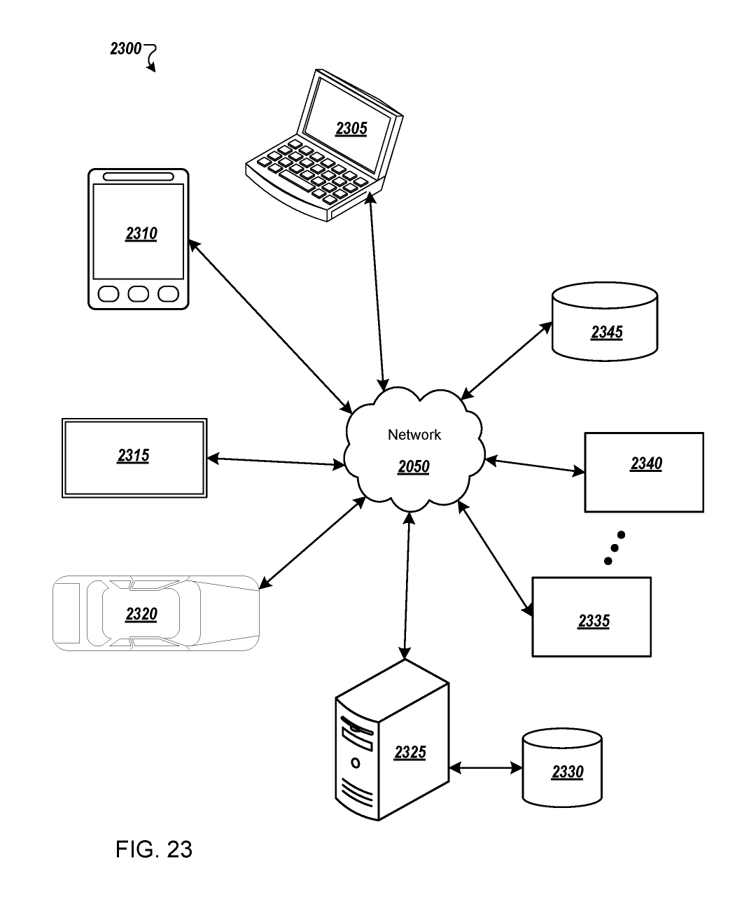

FIG. 23 shows an example environment suitable for some example implementations. Environment 2300 includes devices 2305-2345, and each is communicatively connected to at least one other device via, for example, network 2360 (e.g., by wired and/or wireless connections). Some devices may be communicatively connected to one or more storage devices 2330 and 2345.

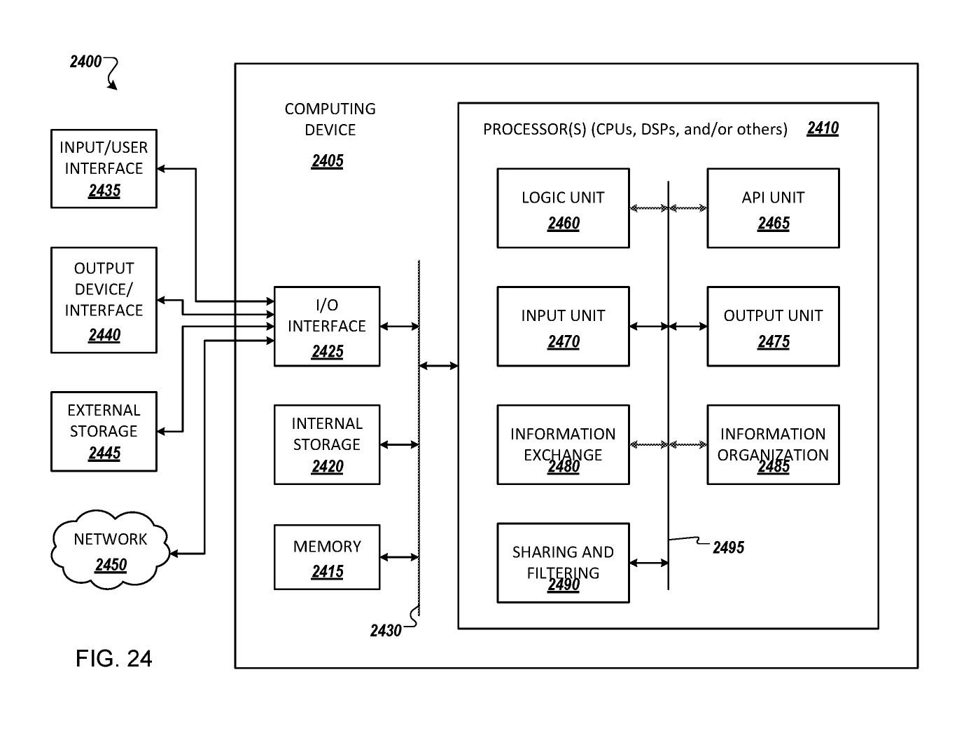

An example of one or more devices 2305-2345 may be computing device 2405 described below in FIG. 24. Devices 2305-2345 may include, but are not limited to, a computer 2305 (e.g., a laptop computing device), a mobile device 2310 (e.g., smartphone or tablet), a television 2315, a device associated with a vehicle 2320, a server computer 2325, computing devices 2335-2340, storage devices 2330 and 2345.

In some implementations, devices 2305-2320 may be considered user devices, such as devices used by users to create content and/or issue requests, such as sharing content on a social network. Devices 2325-2345 may be devices associated with service providers (e.g., used by service providers to provide services and/or store data, such as webpages, text, text portions, images, image portions, audios, audio segments, videos, video segments, and/or information thereabout).

For example, a user (e.g., Alice) may access, view, and/or share content or a photo using user device 2310 on a social network supported by one or more devices 2325-2345. Device 2310 may be running an application that implements information exchange, information organization, sharing or filtering.

FIG. 24 shows an example computing environment with an example computing device suitable for use in some example implementations. Computing device 2405 in computing environment 2400 can include one or more processing units, cores, or processors 2410, memory 2415 (e.g., RAM, ROM, and/or the like), internal storage 2420 (e.g., magnetic, optical, solid state storage, and/or organic), and/or I/O interface 2425, any of which can be coupled on a communication mechanism or bus 2430 for communicating information or embedded in the computing device 2405.

Computing device 2405 can be communicatively coupled to input/user interface 2435 and output device/interface 2440. Either one or both of input/user interface 2435 and output device/interface 2440 can be a wired or wireless interface and can be detachable. Input/user interface 2435 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 2440 may include a display, television, monitor, printer, speaker, braille, or the like. In some example implementations, input/user interface 2435 and output device/interface 2440 can be embedded with or physically coupled to the computing device 2405. In other example implementations, other computing devices may function as or provide the functions of input/user interface 2435 and output device/interface 2440 for a computing device 2405.

Examples of computing device 2405 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computing device 2405 can be communicatively coupled (e.g., via I/O interface 2425) to external storage 2445 and network 2450 for communicating with any number of networked components, devices, and systems, including one or more computing devices of the same or different configuration. Computing device 2405 or any connected computing device can be functioning as, providing services of, or referred to as a server, client, thin server, general machine, special-purpose machine, or another label.

I/O interface 2425 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 2400. Network 2450 can be any network or combination of networks (e.g., the Internet, local area network, wide area network, a telephonic network, a cellular network, satellite network, and the like).

Computing device 2405 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computing device 2405 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Pert, JavaScript, and others).

Processor(s) 2410 can execute under any operating system (OS) (not shown), in a native or virtual environment. One or more applications can be deployed that include logic unit 2460, application programming interface (API) unit 2465, input unit 2470, output unit 2475, information exchange 2480 (e.g., as shown in FIGS. 1-6), information organization 2485 (e.g., as shown in FIGS. 8-19), sharing and filtering 2490, and inter-unit communication mechanism 2495 for the different units to communicate with each other, with the OS, and with other applications (not shown). For example, information exchange 2480, information organization 2485, and sharing and filtering 2490 may implement one or more processes described and shown in FIGS. 1-23. The described units and elements can be varied in design, function, configuration, or implementation and are not limited to the descriptions provided.

In some example implementations, when information or an execution instruction is received by API unit 2465, it may be communicated to one or more other units (e.g., logic unit 2460, input unit 2470, output unit 2475, information exchange 2480, information organization 2485, and sharing and filtering 2490). For example, after input unit 2470 has detected a user action, sharing and filtering 2490 filters and/or shares that action and interfaces with information sharing 2480 to share the information between users. The models may be generated by actions processing 2485 based on previous actions or user history. Input unit 2470 may then provide input from a user selecting or modifying one of the predicted actions. Output unit 2475 then performs the final action based on the user's input.

In some instances, logic unit 2460 may be configured to control the information flow among the units and direct the services provided by API unit 2465, input unit 2470, output unit 2475, information exchange 2480, information organization 2485, and sharing and filtering 2490 in some example implementations described above. For example, the flow of one or more processes or implementations may be controlled by logic unit 2460 alone or in conjunction with API unit 2465.

Although a few example implementations have been shown and described, these example implementations are provided to convey the subject matter described herein to people who are familiar with this field. It should be understood that the subject matter described herein may be implemented in various forms without being limited to the described example implementations. The subject matter described herein can be practiced without those specifically defined or described matters or with other or different elements or matters not described. It will be appreciated by those familiar with this field that changes may be made in these example implementations without departing from the subject matter described herein as defined in the appended claims and their equivalents.

What is claimed is:

1. A computer-implemented method, comprising:
activating an application on a first device of a first user;
detecting a second device of a second user;
in response to a first user input of the first user to the first device and a second user input of the second user to the second device, transmitting first information of the first user to the second decide and transmitting second information of the second user to the first device; and
associating the first information and the second information with social network information of the first user and the second user.

2. The method of claim 1, further comprising the first user filtering availability based on distance to the second user.

3. The method of claim 1, further comprising the first user filtering availability based on one of a blacklist and a whitelist.

4. The method of claim 1, where in the transmitting comprising displaying, on the user interface of the first device, the movement of the first information away from the first user.

5. The method of claim 4, where in the transmitting comprising displaying, on the user interface of the first device, the movement of the second information towards the first user.

6. The method of claim 5, wherein the displayed first information comprises display of a first business card associated with the first user, and the displayed second information comprises display of a second business card associated with the second user.

7. The method of claim 1, further comprising displaying a relative position of the second user with respect to the first user on an interface, wherein the first user can change the relative position by use of gestures on the touchscreen of the first device.

8. A non-transitory computer readable medium having stored therein computer executable instructions for:
activating an application on a first device of a first user;
detecting a second device of a second user;
in response to a first user input of the first user to the first device and a second user input of the second user to the second device, transmitting first information of the first user to the second decide and transmitting second information of the second user to the first device; and
associating the first information and the second information with social network information of the first user and the second user.

9. At least one computing device comprising storage and a processor configured to perform:
activating an application on a first device of a first user;
detecting a second device of a second user;
in response to a first user input of the first user to the first device and a second user input of the second user to the second device, transmitting first information of the first user to the second decide and transmitting second information of the second user to the first device; and
associating the first information and the second information with social network information of the first user and the second user.

10. The computer-implemented method of claim 1, further comprising:
after the associating, for the first user requesting automatic social graph determination, determining a social networking service account of the second user; and
for the second user having the social account, automatically associated the social networking service account of the second user with a social networking service account of the first user.

11. The computer-implemented method of claim 1, further comprising:
after the associating, displaying a social graph of the second user for at least one social networking service account of the second user.
